(19) United States
(12) Patent Application Publication
(10) Pub. No.: US 2003/0152688 A1
(43) Pub. Date: Aug. 14, 2003

(54) Egg-based powder and food containing the same

(76) Inventors: Jean-Pierre Bisson, Caen (FR); Denis Abraham, Coquainvilliers (FR)

Correspondence Address: WINSTON & STRAWN, PATENT DEPARTMENT, 1400 L STREET, N.W., WASHINGTON, DC, 20005-3502, US

(21) Appl. No.: 10/347,465

(22) Filed: Jan. 21, 2003

Related U.S. Application Data
(63) Continuation of application No. PCT/EP01/08095, filed on Jul. 12, 2001.

(30) Foreign Application Priority Data
Jul. 21, 2000 (EP) 00115708.0

(51) Int. Cl. A23L 1/32

(52) U.S. Cl. 426/614

(57) ABSTRACT

An egg-based powder is made available as a gelling and emulsifying component in fermented foods of the drinks, dessert, fromage frais and set or creamy yogurt type and is remarkable in that the entire properties of the eggs are preserved while ensuring the absence of salmonella by using only natural components.

### CROSS-REFERENCE TO RELATED APPPLICATIONS

This application is a continuation of the US national phase designation of International application PCT/EP01/08095 filed Jul. 12, 2001, the content of which is expressly incorporated herein by reference thereto.

### BACKGROUND

The invention relates to a pasteurized egg-based powder whose organoleptic and functional properties are functionally similar to those of egg after reconstituting in an aqueous medium. It also relates to an egg-based fermented food of a novel type, manufactured from such a composition.

Eggs are often used for their excellent functional properties, for example their gelling and emulsifying properties, for their color and taste. It is known that egg-based food products are not free of microbiological risks since eggs may contain sporulated microorganisms and salmonella. Egg proteins usually lose their functional properties, in particular their gelling ability, under the heat treatment conditions which would be necessary for the elimination of such spores and salmonella. Accordingly, industrial egg products are generally pasteurized, but this does not eliminate all risks. Because of residual risks, the use of eggs is limited. In particular, the use of eggs which have been simply pasteurized in a conventional manner under conditions which maintain their organoleptic and functional properties cannot be successfully and safely used in food products which have to undergo fermentation.

A spray-dried composition based on egg and skimmed milk capable of being reconstituted in water is known for example from FR-A-2 118 688. This composition results from drying a mixture of whole egg and skimmed milk which have been separately pasteurized. In particular, the egg is heat-treated at 64.5° C. for 2½ minutes, a treatment that does not make it possible to ensure complete absence of salmonella. Such a complete treatment is not necessary in the context of that document since the egg/milk powder is intended for use in cakes which are manufactured by prolonged baking of the mix at high temperature. In comparison, this composition cannot be safely used in uncooked food products, for example, dairy products.

A fermented drink based on milk and egg is also known for example from FR-A-2 737 643. Such a drink is manufactured by preparing a liquid egg mixture which has been highly diluted in water, supplemented with skimmed milk powder, glucose and fructose and a content of egg not exceeding 10% in the mixture, heat treating by pasteurization, and then cooling followed by lactic acid fermentation of the mixture thus treated. This product is not based on a powder and the egg is treated with a high temperature while being highly diluted in water.

It is also known from EP-A-0 820 704 that it is possible to sterilize a mixture of milk, egg and sugar by the liquid route and, where appropriate, drying the mixture, thereby losing the functional properties of the egg and using the gelling properties of the casein in the presence of calcium under the effect of heat to replace the functional properties of the egg which are lost during the sterilizing heat treatment. The re-established gelling properties of the system are exploited to manufacture desserts of the flan type.

The problem forming the basis of the present invention is the making available of a product based on whole egg, which would have the desired functionality, in particular the emulsifying ability and the gelling capacity, which could be used in the preparation of food products while being hygienic and in particular which would be suitable for the preparation of dairy food products. The prior art does not address this problem.

There also is a need for an easy to use texturizing powder, which has a natural image, the advantage of egg, and which is safe to use in all food products including uncooked foods. This need is now met by the present invention.

### SUMMARY OF THE INVENTION

The invention relates to a texturizing powder for food products, wherein the powder is a pasteurized mixture of egg and milk protein components. The mixture is advantageously pasteurized at a temperature that is sufficiently high to eliminate bacteria and then dried to form a powder that can be safely utilized in uncooked food products. The powder also retains the functional and organoleptic properties of egg after reconstitution in an aqueous medium.

Preferably, the egg component in the mixture is non-coagulated egg and the components are pasteurized at a temperature of above 65° C. The powder is readily obtainable by creating a mixture of the egg and milk protein components, pasteurizing the mixture at a temperature above 65° C., and then drying the pasteurized mixture. Advantageously, the powder is obtainable without adding stabilizing or emulsifying additives, and without adding water before pasteurizing.

A preferred pasteurization temperature is above 67° C., and the resulting material has the property of being easily reconstitutable in water. The milk protein preferably comprises a whey concentrate containing 35 to 80% by weight of proteins, or at least 30% by weight of the dry matter content is derived from whey. The egg component is preferably a low temperature pasteurized whole egg.

The invention also relates to an edible composition comprising a food product or beverage which contains a texturizing-powder in accordance with the invention. This composition is easily reconstitutable in water.

These edible compositions may be in the form of a wide variety of different products. The composition can be prepared in the form of a gelled dessert, a set or creamy fermented milk or yogurt, an acid drink, a dessert mousse, a fromage frais or a mayonnaise. A preferred product is a chilled dairy product which contains pasteurized eggs as a texturizing agent and which has essentially the same functional and organoleptic properties of a chilled diary product that contains fresh eggs. This product is substantially free of other gellifying and texturizing agents, additives, hydrocolloids or gelatine. The dairy product can be chosen from milk drinks, fromage frais, yogurts and desserts that contain from 0.5 to 10% by weight of the texturizing powder of the invention Another embodiment of the invention relates to a process for preparing a texturizing powder, which comprises: mixing egg with a lactic base that is rich in whey or leguminous plant protein to form a mixture, pasteurizing the mixture by a heat treatment conducted at a temperature of above 65° C. while preserving the organoleptic and functional properties of the egg, and drying the pasteurized mixture to form the powder.

### DETAILED DESCRIPTION OF THE PREFERRED EMBODIMENTS

In one preferred aspect, the invention relates to a texturizing powder suitable for use in cooked and uncooked food products, comprising a pasteurized mixture of non-coagulated egg and milk protein wherein the mixture is pasteurized at a temperature above 65° C.

In another preferred aspect, the present invention relates to a texturizing powder for a food product comprising a milk protein component, and an egg component, with the components being pasteurized, in the form of a mixture, so as to eliminate bacteria, the mixture being dried, and the powder retaining the functional and organoleptic properties of the egg once reconstituted in an aqueous medium.

In yet another preferred aspect, the present invention relates to a texturizing powder comprising egg and milk protein, the powder obtainable by creating a mixture of egg and milk protein, pasteurizing the mixture at a temperature above 65° C., and then drying the mixture.

The powder is stable for a long period from a microbiological point of view and has the property of not being susceptible to recontamination as would be the case for a composition in liquid form. Furthermore, there is no phase separation or settling out during storage or upon reconstitution.

Without wishing to be bound by theory it is postulated that the milk or whey proteins protect the egg proteins from coagulation at a temperature above 64° C. This protection may account for the ability to conduct a pasteurization even above 70° C., which means that hygiene criteria for many uncooked products are met, while at the same time the functional properties of egg are not lost.

The present invention also relates to a food product or a beverage which contains the powder. Alternatively, a chilled dairy product can be prepared which contains pasteurized eggs as a texturizing agent and which has the same organoleptic properties of a product containing fresh eggs. In another aspect, the present invention provides a process for manufacturing a chilled dairy product, in which a mixture of whole milk or milk which has been skimmed to a greater or lesser degree, carbohydrates and the powder set out above is prepared by dissolution and the mixture is treated by lactic acid fermentation.

In another aspect, the present invention relates to the use of the powder described above as a replacement for egg in an egg-based product. This powder can be obtained without addition of stabilizing or emulsifying additives, and without adding water before pasteurization.

The powder is easily reconstitutable in water. Preferably, the dry weight ratio of egg to milk protein in the powder is 0.5:1 to 1.5:1, more preferably 0.8:1 to 1.2:1. If the milk protein is whey protein, the powder preferably comprises 35 to 55% of whey protein and 45 to 65% by weight of egg, with respect to dry matter. More preferably, it comprises 40 to 50% whey protein and 50 to 60% of egg.

The milk proteins are preferably derived from a whey concentrate containing 35 to 80% by weight of proteins. Such a concentrate is advantageously obtained from the ultrafiltration or the microfiltration of sweet or acid whey from casein making or from cheese making.

Pasteurization temperatures above 65° C., preferably above 67° C., even more preferably above 70° C., 72° C., 74° C. or 76° C., are used. The pasteurization temperature is generally between 70 and 75° C. In one embodiment, the pasteurization temperature is between 65° C. and 78° C., preferably between 70 and 76° C., and most preferably is between 72 and 76° C.

The egg preferably is a low temperature pasteurized whole egg. Low temperature pasteurization of egg, in the context of the present invention, refers to a pasteurization temperature, which is equal to or lower than 65° C. In general, it refers to a temperature at which the egg proteins contained in egg do not coagulate. For undiluted eggs or eggs not supplemented by additives this temperature is considered to be around 64.5° C.

As noted above, at least 30% by weight of the dry matter content of the powder is derived from whey.

The invention also relates to a process for preparing a product above, in which a concentrated lactic base rich in whey protein or in leguminous plant protein, and liquid egg is mixed, and then the mixture is pasteurized by heat treatment at above 65° C. while preserving the organoleptic and functional properties of the egg are the mixture is dried.

In an embodiment of the process, in which the egg component and the lactic base are mixed, the pH is adjusted, where appropriate, to a value ranging from 6.5 to 7.5, and the mixture is then pasteurized at a temperature of at most 78° C. for 10-20 s.

In the context of the invention, the expression lactic base rich in whey protein is understood to mean any raw material of lactic origin containing lactic proteins, rich in serum proteins, in particular in lactalbumins. It is possible to use any raw material containing whey proteins in concentrated form, for example an acid whey from casein making or a sweet whey from cheese making, obtained by separating the curd containing the casein, preferably concentrated by ultrafiltration or microfiltration, followed, where appropriate, by diafiltration (ultrafiltration with washing with water). The concentrate may be demineralized or made lactose free to a greater or lesser degree.

As a variant, it is possible to use, as source of lactic protein, a vegetable milk, for example a soybean milk, concentrate or isolate, with a high concentration of proteins. Equally, the milk protein may be replaced by meat protein.

The liquid egg which may be used in the process of the invention may be a mixture of egg yolk and egg white, or preferably a whole egg in liquid form, which has been pasteurized beforehand. It is possible to use fresh egg, ripened egg, that is to say which has been stored at refrigeration temperature, for example at about 4° C., for a period of up to several days, a mixture of egg white and egg yolk having been ripened separately, whole egg enriched with egg yolk or with egg white, all these raw materials having been separately pasteurized.

To carry out the process, the undiluted egg component and the milk protein component are mixed, with stirring, the pH is adjusted, where appropriate, to a value ranging from 6.5 to 7.5, and then the mixture is preheated, for example using a plate exchanger, preferably at a temperature of less than or equal to 75° C.

The pasteurization treatment may be carried out in an indirect manner by means of a plate exchanger. As a variant, it is possible to carry it out in a jacketed holding unit. The pasteurization should be carried out under conditions which are lethal for salmonella while making it possible not to coagulate the egg, in short to preserve its functional qualities, in particular its emulsifying and gelling powers, and its organoleptic qualities, in particular its taste and its color. It takes place preferably at a temperature of at most 76° C. for 10-20 s.

The mixture in question is then dried, for example spray-dried in a drying tower under moderate to medium conditions.

Once dried, and where appropriate supplemented with other dehydrated ingredients of the recipe, the mixture may be reconstituted with an aqueous medium and then subjected to subsequent treatment for preparing an egg-based food as a replacement for egg.

Thus, the powder according to the invention may be used as a basic ingredient in any food comprising the use, in the form of a mixture, of milk, egg and carbohydrates with the aim of forming a gel upon cooking. There may be mentioned savory culinary preparations for flan, omelettes, quiches or sauces, or sweetened preparations for pastry, in particular for cakes, creams or flans.

In the food or beverage products of the invention, the powder is included as a texturizing agent. Alternatively, the product may contain pasteurized eggs as a texturizing agent. The pasteurized eggs or the reconstituted powder have essentially or exactly the same functional or organoleptic properties of a product containing fresh eggs. Generally, these products are free of other gellifying and texturizing agents, additives, hydrocolloids or gelatine.

The invention also relates to dairy product containing egg, chosen from milk drinks, yogurts and desserts, containing 0.5 to 10% by weight of a powder above. The product may be in the form of a gelled dessert of the flan or mousse type. It may be in the form of set or creamy yogurt. It may also constitute an acid drink or a fromage frais. In an embodiment, the food product is a mayonnaise.

The invention also relates to a process for manufacturing a fermented food product above, in which a mixture of whole milk or milk which has been skimmed to a greater or lesser degree, carbohydrates and powder described above is prepared by dissolution and the mixture is treated so as to form a gel by lactic acid fermentation.

It is possible to start with fresh milk, standardized by adding cream or vegetable fat. It is also possible to start with milk reconstituted from skimmed milk powder and anhydrous lactic fat.

The carbohydrates which may be used in the above process are in particular sucrose and lactose, when it is desired to use the product according to the invention to manufacture a sweetened food, alone or in the form of a mixture. The carbohydrates represent 3 to 20% and preferably about 10% by weight of the mixture.

After dissolution, the mixture may be pasteurized, for example at 90-105° C. for 2 to 10 min, cooled to about 70-75° C. and then homogenized in a 1 or 2-stage homogenizer, preferably, for a single stage, at a pressure of 75 to 300 bar, or for two stages, at pressures of 75/15 bar to 300/60 bar, and then cooled to a temperature, chosen for the fermentation, of 25 to 45° C.

The fermentation is carried out in a conventional manner. To do this, it is possible to use lactic ferments in yogurt and/or in fromage frais, where appropriate with probiotic ferments.

A gel may be prepared which may constitute the final fermented product. It is also possible to smooth the fermented mass or to give it a degree of overrun.

The fermented product thus obtained may constitute the final product or may constitute a fermented filling, where appropriate in the presence of other components as receptacle, inclusions, accessories or flavoring ingredients.

The heat treatment for pasteurizing the eggs in the form of a mixture with the milk proteins does not destroy the functional properties of the egg proteins. Thus, the preparation of a food, for example a flan or a mousse, remains possible by virtue of the exploitation of the gelling properties and of the overrun and emulsifying capacity of the egg proteins. In particular, the powder according to the invention is suitable for conventional cooking in a hot air oven or even for indirect sterilization in a heat exchanger, for example at 120-125° C./20 s in the presence of the other ingredients of the dessert.

If a mayonnaise is produced, the powder according to the present invention may replace part or all of the egg in the mayonnaise. Any mayonnaise may be produced with the powder, for example 80% fat, 50% or 35% fat (in percent by weight). The contents of all ingredients may therefore be varied according to personal gusto. Usually, all ingredients of the mayonnaise, including the powder, are mixed and the oil is emulsified in, which may be by batch wise operating emulsifier machines, with continuous emulsifier machines or with colloid mills. Different oil-drop sizes may be obtained by this process, for example 3 to 10 μm.

If the fat content is desired to be lower, there are usually thickeners mixed separately in an aqueous solution, heated and finally introduced into the basic mayonnaise as obtained above. In general, the same recipies like known may be used and the classic egg powders are just partially or totally replaced by the powder according to the present invention.

### EXAMPLES

The examples below illustrate the invention. In these examples, the parts and percentages are by weight, unless otherwise stated.

### Example 1

Preparation of a Powder

A sweet whey concentrate from cheese making, obtained from ultrafiltration and containing 35% of protein, is dissolved in water and liquid whole egg, pasteurized beforehand, is added in a tank, with stirring, so as to obtain 55.5% egg dry matter content per 44.5% whey dry matter content.

After having adjusted, where appropriate, the pH to a value of 6.8 to 7.2 by adding a food grade concentrated aqueous sodium hydroxide solution, the mixture is pumped, by means of a positive pump, to a plate exchanger where it is heated to 72° C. and maintained at this temperature for 15 s; it is cooled to 60° C. and then it is spray-dried in a drying tower in an air stream, the hot air admission temperature being 190° C. and the air outlet temperature 92° C.

### Example 2

Preparation of a Filling for Quiche

The powder of Example 1 is used by dissolving it in an amount of 3.5% in 87.5% whole milk and adding 9% sucrose, as a base for producing a quiche Lorraine. After baking in an oven in a conventional manner, the texture and the taste of the quiche are similar to those of a traditional quiche.

### Example 3

Preparation of a Fermented Dessert Fan

The powder of Example 1 is used by dissolving it in an amount of 2.88% in 84.6% whole milk and adding 8.72% sucrose. After pasteurizing at 105° C./2 min, the mixture is cooled to 45° C. and homogenized in a 2-stage device at an overall pressure of 300 bar, and it is then cooled to 40° C. It is inoculated with 3.8% of a mixture of ferments for yogurt and it is incubated at 40° C. until a pH of 4.7 is obtained. The product thus obtained is cooled in a cold chamber at 4-6° C. and stored at this temperature. After cooling, the firmness of the gel is totally comparable to that of a home-made flan obtained conventionally from fresh eggs.

### Example 4

Preparation of a Stirred Yogurt

The powder of Example 1 is used by dissolving it in an amount of 3.42% in 84.12% of whole milk and by adding 8.66% sucrose. After pasteurizing at 105° C./2 min, the mixture is cooled to 45° C. and homogenized in a single-stage device at 300 bar, and it is then cooled to 40° C. It is inoculated with 3.8% of a mixture of ferments for yogurt and incubated at 40° C. until a pH of 4.6 is obtained. The fermented mixture is then smoothed, cooled to 6° C. and poured into pots which are sealed.

### Example 5

Preparation of an Egg-based Fermented Drink

The powder of Example 1 is used by dissolving it in an amount of 2.48% in 80.85% of water and adding 8.2% of sucrose, 7.07% of powdered skimmed milk and 1.38% of anhydrous lactic fat. After pasteurizing at 105° C./2 min, the liquid is cooled to 75° C. and the mixture is homogenized in a 2-stage device at an overall pressure of 300 bar and it is then cooled to 40° C. It is inoculated with 0.02% of a thermophilic lactic ferment for yogurt and incubated at 40° C. until a pH<5 is obtained; the curd mass is smoothed and cooled to 6° C. Pots are then filled and sealed in a traditional manner.

### Example 6

Preparation of a Gelled Fermented Milk

A fatty gelled fermented milk of the yogurt type enriched with probiotic bacteria is prepared. 89.3 parts of milk respectively containing 30 g/l of lactic fat are mixed with 3.7 parts of powder of Example 1 and the mixture is preheated to 70° C.; it is pasteurized at 92° C./6 min and then, after cooling to 70° C., it is homogenized in a single-stage device at 300 bar. After cooling to 43° C., the mixture is inoculated with 2% of a common yogurt starter Streptococcus thermophilus and Lactobacillus bulgaricus, to which 5% of Lactobacillus johnsonii (La1, CNCM I-1227) is added. After packaging in pots, the fermentation is carried out at 38° C. until a pH of 4.6 is obtained, and then cooled to 6° C.

### Example 7

Preparation of a Dessert Mousse

A pasteurized base which can be caused to acquire a degree of overrun, consisting of a mixture of lactic proteins, sugar, powder of Example 1, chocolate and cocoa, is prepared so as to manufacture a chocolate mousse, starting with the ingredients and in the proportions indicated in Table 1 below.

TABLE 1

| Ingredients | % |
|---|---|
| Whole milk or skimmed milk or water | 57.8 |
| Powder according to Example 1 | 4.6 |
| Sucrose | 14.6 |
| Dark chocolate and alkalized chocolate | 21 |
| Cocoa powder | 2 |

The ingredients are mixed, they are preheated to 70° C. and then they are heat-treated by UHT with direct injection of steam at 143° C./10 s. After cooling by expansion under vacuum at 70° C., and then by plate exchanger at 10° C., the mixture is aerated in a Mondomix® apparatus for producing overrun until an overrun of 75-100% by volume is obtained.

### Example 8

Preparation of a Mayonnaise

An 80% fat mayonnaise (percent by weight) is prepared by mixing and stirring all ingredients but oil present in table 2 below. Then oil is emulsified in continuously with a roto/strato emulsifier machine. In so doing, a mayonnaise with a mean oil drop size of 3-10 μm is achieved.

TABLE 2
Ingredients for preparation of a 80%-fat mayonnaise

| Ingredients | % |
|---|---|
| Water | 8.6025 |
| Salt | 1.1000 |
| Spirit vinegar 11% | 2.700 |
| Lactic acid 88% | 0.7780 |
| Sunflower oil | 80.000 |
| Egg-milk powder from example 1 | 4.000 |
| Flavor, spices | 2.8195 |

What is claimed is:

1. A texturizing powder for food products, the powder comprising a pasteurized mixture of egg and milk protein components, wherein the mixture is pasteurized at a temperature that is sufficiently high to eliminate bacteria and then dried to form a powder that can be safely utilized in uncooked food products and that retains the functional and organoleptic properties of egg after reconstitution in an aqueous medium.

2. The texturizing powder of claim 1, wherein the egg component in the mixture is non-coagulated egg and the components are pasteurized at a temperature of above 65° C.

3. The texturizing powder of claim 1, obtainable by creating a mixture of the egg and milk protein components, pasteurizing the mixture at a temperature above 65° C., and then drying the pasteurized mixture.

4. The texturizing powder of claim 3, which is obtainable without adding stabilizing or emulsifying additives, and without adding water before pasteurizing.

5. The texturizing powder of claim 3, wherein the pasteurization temperature is above 67° C.

6. The texturizing powder of claim 1, which has the property of being easily reconstitutable in water.

7. The texturizing powder of claim 1, in which the milk protein comprises a whey concentrate containing 35 to 80% by weight of proteins.

8. The texturizing powder of claim 1, in which at least 30% by weight of the dry matter content is derived from whey.

9. The texturizing powder of claim 1, wherein the egg component is a low temperature pasteurized whole egg.

10. An edible composition comprising a food product or beverage which contains the texturizing powder of claim 1.

11. The composition of claim 10 which is reconstitutable in water.

12. The composition of claim 10 which is a mayonnaise.

13. The composition of claim 10 in the form of a gelled dessert, a set or creamy fermented milk or yogurt, an acid drink, a dessert mousse, a fromage frais or a mayonnaise.

14. A chilled dairy product which contains pasteurized eggs as a texturizing agent and which has essentially the same functional and organoleptic properties of a chilled diary product that contains fresh eggs.

15. The product of claim 14, which is substantially free of other gellifying and texturizing agents, additives, hydrocolloids or gelatine.

16. A dairy product chosen from milk drinks, fromage frais, yogurts and desserts that contain from 0.5 to 10% by weight of the texturizing powder of claim 1.

17. A process for preparing a texturizing powder according claim 1, which comprises: mixing egg with a lactic base that is rich in whey or leguminous plant protein to form a mixture, pasteurizing the mixture by a heat treatment conducted at a temperature of above 65° C. while preserving the organoleptic and functional properties of the egg, and drying the pasteurized mixture to form the powder.

18. The process of claim 17, which further comprises adjusting the pH, when necessary, to a value ranging from 6.5 to 7.5 prior to pasteurizing the mixture at a temperature of at most 78° C. for 10-20 seconds.

19. A process for preparing a food product or beverage which comprises preparing a mixture of skimmed milk, carbohydrate and the texturizing powder of claim 1 by dissolution, and then treating the mixture by lactic acid fermentation.

20. An egg replacement composition for use as a replacement for egg in an egg-containing food product, comprising the powder of claim 1.
